(19) United States
(12) Patent Application Publication
(10) Pub. No.: US 2021/0124310 A1
(43) Pub. Date: Apr. 29, 2021

(54) SOLID STATE SHADOW LIGHT CLOCK

(71) Applicant: DAVID BRYCE TURNER, FORT WORTH, TX (US)

(72) Inventor: DAVID BRYCE TURNER, FORT WORTH, TX (US)

(21) Appl. No.: 17/064,600

(22) Filed: Oct. 7, 2020

Related U.S. Application Data
(60) Provisional application No. 62/927,127, filed on Oct. 29, 2019.

(51) Int. Cl. G04G 9/00

(52) U.S. Cl. CPC G04G 9/00

(57) ABSTRACT

A solid state light shadow clock including construction of multiple light sources about the perimeter illuminated inward to cast shadows displaying apparent rotation about the center at the speed of clock hands; at a speed of one revolution per hour, at the speed of one revolution per twelve hours, and at the speed of one revolution per minute; a circumferential inward facing arrangement of light emitting devices to cast shadows at various lengths and color combinations. The clock comprises radial shadows cast in representation of the arms of a clock. The shadow clock display may be incorporated in devices ranging in size from portable devices to large public displays.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### THE NAMES OF PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

### 1. Field of the Invention

Various attempts have been made to provide illuminated clocks which are decorative yet highly functional. It is an object of this invention to provide a truly unique, appealing and attractive clock which uses shadows to indicate the time with a variety of color and pattern effects.

### 2. Description of Prior Art

Prior attempts have been made to simulate the passage of time by casting lights and/or shadows through mechanical means, but the present art does not have any moving parts. One such Shadow Clock is shown in U.S. Pat. No. 4,034,549 to Danley. In this device, the clock relies upon a mechanical construction with many moving parts, gears, and motors to differentiate its shadow across the clock face. While such a clock is decorative, it does not fully capture the precision of each individual clock hand, it does not show their distinct movement across the clock face, and the many dependencies on moving parts could be more prone to failure.

### BRIEF SUMMARY OF THE INVENTION

In accordance with the present invention, a clock is provided for telling time by casting real shadows of a centrally mounted (protrusion/pillar) onto indicia on the face of the clock. The device comprises multiple angles of light from the interior perimeter toward the center. The shadow will cast opposite the light across indicia on the face of the clock. To achieve the appearance of varied length hands the light sources along the perimeter will have varied heights. The pillar will sit in the center of the clock face so as to give the appearance of varied length hands with the shadows cast by the lights.

More particularly, a clock is provided in one embodiment having a face with indicia spaced 30° therearound to represent the hours of the day and smaller 6° indicia therebetween to represent minutes of time. The device comprises a pillar mounted about the center of the face. The shadows are rotated by alternating light sources illuminating inward casting a shadow across the face to determine the time. Means for simulating clock hands through shadows is provided for selectively illuminating the light emitting device opposite the number to which the pillar is indicating and remains illuminated until the light source transitions to the subsequent number whereupon the subsequent light will be illuminated and previous light dimmed so that the light means casts a shadow of the pillar across the indicia opposite the illuminated light sources to the subsequent number. This pattern gives the effect of clock hands in rotation.

### BRIEF DESCRIPTION OF THE SEVERAL VIEWS OF THE DRAWINGS

The invention will be described in detail below with reference to the accompanying drawings, in which:

FIG. 1 is a perspective view of the clock according to the preferred embodiment of the invention with light emission means about the interior and a centrally mounted pillar.

FIG. 2 is a perspective view from the front face of the clock frame in a time-displaying state according to the preferred embodiment of the invention.

FIG. 3 is a cross-sectional side view of the clock display according to the preferred embodiment of the invention with light emission means about the interior perimeter.

### DETAILED DESCRIPTION OF THE INVENTION

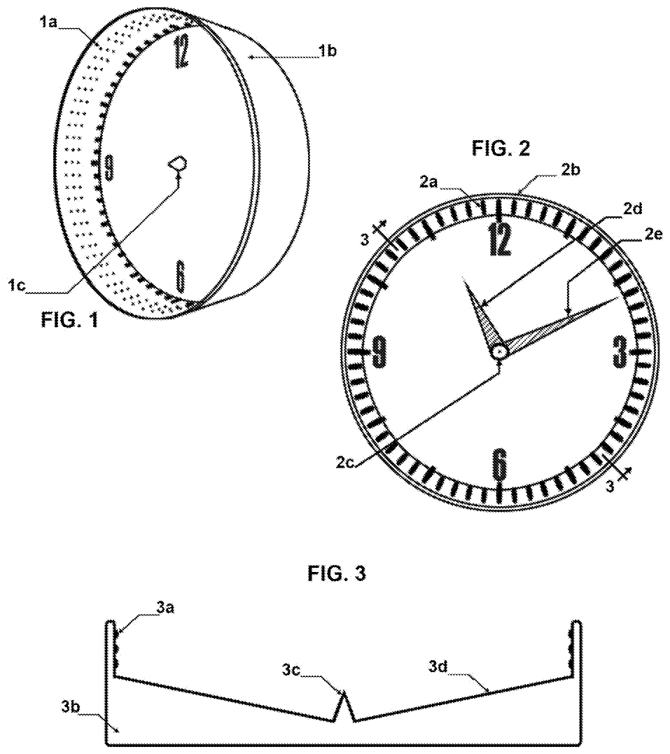

In accordance with one form of this invention, a clock is provided having a face with indicia for the hours, minutes and seconds of time, as shown in FIG. 1. a pillar (1c) protrudes about the center of the face. The interior perimeter of the clock face comprises light emitting devices (1a) to cast radial shadows for the respective clock hands. The construction of the clock frame (1b) in its preferred embodiment would be of plastic, but it may be of any suitable medium.

FIG. 1 shows a preferred embodiment of the analog clock display invention in a perspective view in a non-time displaying state. The clock display comprises light sources for each hand of time which may have the desired function such as changing color, fade-in and fade-out, steady on single color, time delay with sensor means, touch means for short time illumination, or any other light function available from conventional market skills. The preferred embodiment also comprises electronic circuitry (not shown) to give the clock high accuracy and illuminating entertainment.

FIG. 2 shows a preferred embodiment of the analog clock display in a time-displaying state seen as a perspective view toward the front face of the clock frame (2b) in which light emitting devices (2a) are mounted about the interior perimeter directed toward the centrally mounted pillar (2c) such that shadows (2d, 2e) are cast radially providing a means to determine the time.

FIG. 3. shows a preferred embodiment of the analog clock display in traverse perspective to show the depth of its frame (3b) to supply a perimeter of light sources at variable heights (3a) relative to the centrally placed pillar (3c) in a convex cone shape so as to display shadows without being as washed out by competing lights (3d). The current invention uses the space in the base of the clock frame (3b) to install the electronic circuitry (not shown), and some necessary power means (not shown). This will allow the whole embodiment to have built-in light functions.

1. A clock display instrument for determining time by projecting shadows as clock hands, the instrument comprises:
A shell with a hollowed out interior holding a pillar in the center forming the face of the clock;
The interior perimeter of the face contains light emitting sources facing toward the center that shift in position such that clock hands are simulated.

2. A clock display according to claim 1, wherein the unit is adapted with light emitting sources at various heights relative to the central pillar to simulate variable length clock hands.

3. A clock display according to claim 1, wherein the unit is adapted to control various light illumination levels and color combinations.

4. A clock display according to claim 1, wherein the unit is adapted with a convex conical feature on the face of the clock to better display shadows.
